(19) United States
(12) Patent Application Publication
(10) Pub. No.: US 2025/0376000 A1
(43) Pub. Date: Dec. 11, 2025

(54) AIR HEATER FOR MOBILE APPLICATIONS, WITH AXIALLY MOUNTABLE HOUSING SHELLS

(71) Applicant: Webasto SE, Stockdorf (DE)

(72) Inventors: Bernhard Diepold, Stockdorf (DE); Sebastian Kloss, Stockdorf (DE); Alina Mogos, Stockdorf (DE); Christoph Hampel, Stockdorf (DE); Damir Skaljo, Stockdorf (DE)

(21) Appl. No.: 19/223,936

(22) Filed: May 30, 2025

(30) Foreign Application Priority Data
Jun. 5, 2024 (DE) 102024205193.4

(51) Int. Cl. B60H 1/00; B60H 1/22

(52) U.S. Cl. CPC B60H 1/00521; B60H 1/2203

(57) ABSTRACT

An air heater for a vehicle, which comprises a subassembly for generating heat; a heat exchanger element thermally interacting with the subassembly; an external housing which receives the subassembly and the heat exchanger element, where the external housing and the heat exchanger form a heating air channel between them; a heating air blower, which is configured to draw in heating air via a heating air inlet of the external housing, convey this in a flow direction through the heating air channel and output it via a heating air outlet of the external housing; and a combustion air blower module comprising a combustion air blower which is powered by a motor and is configured, during operation, to draw in combustion air and supply the combustion air to the subassembly for generating heat.

### CROSS-REFERENCE TO RELATED APPLICATION

This application claims priority to German Application No. DE 102024205193.4 filed on Jun. 5, 2024, which is incorporated herein by reference in its entirety for all purposes.

### TECHNICAL FIELD

The present invention concerns an air heater for mobile applications, with axially mountable housing shells.

### BACKGROUND

Air heaters for mobile applications, in particular in vehicles or construction machines, are conventionally operated on the basis of fuel. Heat is released in a combustion chamber from a fuel supplied from a tank. In a heat exchanger, the hot combustion gases emit part of the usable thermal energy to heating air conveyed via a heating air blower. The air to be heated (in the present document, also called heating air) is conducted over the heat exchanger by the heating air blower (generally located upstream) via a housing shell, normally single-walled, of an external housing. Such housing shells serve in particular for targeted air conduction.

An external housing may comprise one or more housing shells which are usually formed from plastic. The external housing or the corresponding housing shell is installed on the air heater in such a way as to be slightly spaced from the outer ribs, which extend outwards from a main body of the heat exchanger, so that one or more heating air channels are formed in the gap, through which the heating air blower can convey the heating air. The external housing or corresponding housing shells, however, substantially follow an outer contour of the air heater as a whole.

In the heating air channel concerned, the ribs of the heat exchanger enlarge the contact area between the heat exchanger and the heating air, and conduct the heating air into individual flow channels between the ribs. This achieves an efficient transmission of heat between heat exchanger and heating air. The heating air warms up along the resulting flow path and is finally transmitted to a downstream application, for example a hose system with one or more outflow openings in the passenger compartment of the vehicle.

In the region of the heating air blower, which is provided by a corresponding impeller, the external housing simultaneously serves as a blower housing. The heating air is conducted aerodynamically along the heater, through the external housing, between the heating air inlet and the heating air outlet. Furthermore, the pressure rise generated by the heating air blower relative to the atmospheric pressure level of the environment of the air heater is supported. In the region of the heat exchanger, the housing additionally fulfils a function of thermal insulation. In particular, it insulates the environment against the high temperatures of the heating air and also of the heat exchanger ribs.

Forming the external housing from multiple pieces is suitable not only because of the multiple functions of the external housing, but primarily because of the requirements of the production process and the mounting of the components of the air heater, and in some cases also because of the design. External housings are known which have up to five housing shells, also referred to below as housing elements.

DE 10 2021 112 943 A1 discloses an air heater which has at least three housing shells. The external housing comprises a housing body, which is constructed from two housing body portions arranged one behind the other in the direction of the housing longitudinal axis. The first housing body portion of the housing body is constructed from a housing main part and a housing lid, which provides access to the interior of the heater housing from obliquely above or from the side. The second housing body portion, which is formed substantially only on the rear end face of the air heater, comprises the heating air outlet and can be fitted in various positions for angling the outlet. It is formed as one piece in itself and, like the two-piece first housing body portion, is made from a plastic material.

However, such a structure entails some disadvantages. A comparatively high mounting complexity results from a total of 3, in some cases up to 5 individual parts. Furthermore, increased costs result from a complex mounting with 2 main joining directions (e.g. axial and laterally radial). In addition, because of the multiple parts, large gap surfaces occur due to the high number of joining points and, associated therewith, in some cases an increased leakage of the heating air, which must be compensated by an increased demand for electrical drive power. Also, because of the multiplicity of parts, the positioning of edges and gaps is aerodynamically more problematical, in particular in the region of the outflow from the heating air blower. Also, complex tolerance chains with respect to the impeller of the heating air blower must be taken into account, together with the low mechanical stability, in particular in the region of the inlet and outlet hoods. The overall result is a design with different gap sizes and low haptic robustness.

### SUMMARY

The present invention is therefore based on an object of providing an air heater with significantly reduced mounting complexity. Furthermore, additional objectives are to increase the stability of the external housing, to reduce gap surfaces between housing parts, to improve the tolerances between housing and functional parts (such as the heating air blower) or heat-conductive parts, and to keep the leakage and flow resistance for heating air within limits.

According to the invention, in this respect an air heater is proposed for mobile applications, e.g. for a vehicle, which in particular may be a fuel-based air heater. Vehicles are cars, trucks, motorhomes, trailers for cars or trucks, or caravans, construction machines, motor-powered or sailing ships, or house-boats etc., and the invention is not restricted to specific applications.

The air heater has a subassembly for generating heat and a heat exchanger which thermally interacts with the subassembly. The heat exchanger is here configured to receive the thermal energy generated by the subassembly and transmit this to a medium, in particular to heating air. To this end, the air heater furthermore has an external housing which receives the subassembly and the heat exchanger, heat exchanger element, respectively. The external housing and the heat exchanger may here form between them a heating air channel, formed for example by an inner wall of the external housing and an outer wall of the heat exchanger. In this heating air channel, the heating air may be conducted over or past the heat exchanger in order to receive heat therefrom. In order to form the heating air channel, the external housing may be spaced from the heat exchanger. The external housing may delimit the heating air channel towards the outside.

The air heater furthermore has a heating air blower which is configured to draw in heating air via a heating air inlet of the external housing, and convey this in a flow direction through the at least one heating air channel, and output the heating air via a heating air outlet of the external housing. In a preferred embodiment, the heating air blower is connected upstream of the heating air channel (against the flow direction). This may relieve the thermal load on a drive or motor of the heating air blower, and also on a corresponding impeller and its bearings. The heating air inlet and the heating air outlet form openings in the external housing. The air heater establishes a longitudinal axis L extending through the heating air inlet and the heating air outlet. The fact that the heating air outlet may be adjoined by heating air lines which bend away and should no longer be regarded as part of the external housing, is unimportant. Since the heating air blower and the combustion air blower are usually driven by a common motor, and the impeller of the heating air blower should be arranged symmetrically behind the heating air inlet, the longitudinal axis thus established usually coincides with the drive shaft of the motor or is at least parallel thereto.

The heater furthermore also comprises a combustion air blower module, comprising a combustion air blower which is powered by a motor and is configured to draw in combustion air during operation and supply the combustion air to the subassembly for generating heat. The combustion air blower module may consist of multiple individual components which constitute, inter alia, the combustion air blower. The combustion air blower may advantageously be a side channel compressor. In such a case, the combustion air blower module comprises, for example, the two housing parts forming the channel and the corresponding impeller etc.

According to a first aspect of the invention, the combustion air blower module is configured to carry the external housing. This means that, after assembly, the external housing and the combustion air blower module form a stable unit with one another. It is not excluded that further contact points exist between the external housing and functional components of the air heater, e.g. in the region of the heat exchanger, such as any thermally insulating and/or mechanically acting damping elements or spacers etc. However, preferably, only the connection between the combustion air blower module and the external housing fulfils the requirements for the mechanical stability and integrity of the device.

The external housing may have a one-piece or a multipiece construction. This means that indeed also two or more housing shells may be present, which—mutually complementarily—form an inner space which receives (amongst others) the subassembly for heat generation and the heat exchanger. The external housing has at least one first housing element and one second housing element as separate components, which must be joined together on assembly of the air heater and thereby encase the functional components of the air heater.

According to the present aspect of the invention, it is now proposed that the first housing element and the second housing element are latched together in the axial direction, parallel to the longitudinal axis, by at least one, preferably two latch connection(s). In other words, on assembly of the air heater, the two housing elements are fitted in one and the same direction (including the opposite direction), namely along the longitudinal axis of the air heater. It is assumed here that a latch connection more or less unambiguously establishes an engagement direction, which corresponds to the fitting direction of the corresponding housing part, and in the present case coincides with or is parallel to the longitudinal axis.

According to this aspect of the invention, accordingly the combustion air blower module provides a central connecting element or anchoring point for the just two housing elements, which may in some exemplary embodiments be an air inlet hood and an air outlet hood—i.e. two housing elements, of which one may comprise the heating air inlet and the other the heating air outlet.

In particular, according to some exemplary embodiments, it may be provided that the design of a housing part of the combustion air blower module is adapted so as to provide a stable anchoring point for the two housing parts, which can thus now be mounted, after pre-assembly of all other components of the heater, in the same direction (or opposite directions) along the heater axis or longitudinal axis.

According to some exemplary embodiments, the two housing elements may thus be fastened to an anchoring point on the combustion air blower module via a robust latching, which improves the mechanical stability. For this, the combustion air blower module may itself provide a third housing element, on which the two housing elements are latched.

According to an alternative, particularly preferred exemplary embodiment, the two housing elements may be latched directly to one another without a third housing element, both being carried jointly by the combustion air blower module.

Overall, according to this aspect of the invention, the tolerance chains to be considered in the design are significantly simplified by a lower number of parts (two housing elements instead of formerly three or more). This is accompanied also by a reduction in the joining gaps; in particular, however, an avoidance of gaps in the region of the outflow from the heating air blower, mounted upstream inside the device, so that a significant reduction in heating air leakage and consequently an improved volumetric efficiency of the heating air blower can be achieved. The aerodynamic improvement also leads to a reduction in aero-acoustic sound sources (in particular radiant noise and swirl noise), and thus as a whole improves the acoustic properties of the air heater.

However, particular emphasis should be placed on the advantage that, in contrast to the described prior art, substantially now only a single direction alone is required for mounting the components of the air heater. In other words, one main mounting direction is omitted. This simplifies mounting during production and also ease of maintenance in fitted state. In addition, because of the proposed structure, the impeller of the heating air blower and also the control unit can be accessed without extensive removal of components of the device, in that e.g. only the one housing element is unlatched and removed.

A further advantage may be that, according to particular exemplary embodiments, a (second) housing element is provided, which is formed as an air outlet hood and made for example of foamed plastic in a closed-pore design, and hence the thermal insulation of the housing in the region of the heat exchanger is substantially improved. Because the external housing can be assembled along the longitudinal axis, two housing elements may be provided, the one of which in dedicated fashion covers the heat exchanger in the axial direction, and the other covers the electronics and the heating air blower. It is therefore advantageously possible to adapt the two housing elements especially to the respective prevailing requirements (temperatures, mechanical damping, strength or elasticity through thickness etc.).

Particular exemplary embodiments may provide that the combustion air blower module provides a frame, which is formed integrally with a one-piece combustion air blower housing component, and on the outside of which a third housing element is fitted, as mentioned above. This frame holds the third housing element from the inside, and the first and second housing elements are latched thereto. The connection between frame and third housing element may be arbitrary, in particular by form-fit latching, bonding, surround-moulding, or by force fit etc. The third housing element is considered part of the combustion air blower module. The third housing element and the combustion air blower housing component may be produced in advance and provided as a common component during mounting. The outer frame allows flow passages between itself and the combustion air blower for forming the heating channels. Such an exemplary embodiment is described further below. The advantage may be a particularly stable structure. However, this frame requires further production steps such as milling work, in order to provide the cable passages necessary at this point and openings for the latch connections between the housing elements.

According to a refinement of the first inventive aspect, the combustion air blower module therefore comprises, as well as such an integrally formed combustion air blower housing component which at least partially forms the combustion air blower, also a number of holding elements which extend substantially in the radial direction away from the longitudinal axis and support the external housing from the inside. This makes it possible to omit the cohesive outer frame. In addition, the third housing element may thereby also be omitted, since the holding elements press from the inside only against the first housing element, only against the second housing element or—as preferred—against both housing elements simultaneously.

Thanks to the omission of the frame of the combustion air blower, for example, a combustion air blower housing component is produced which, in the case of a diecasting, is substantially simpler with respect to the casting process. For example, around 30% less material may be required, and the material can be distributed in the mould much more easily. Indeed, for the combustion air blower housing component, a central gate point in the corresponding mould is preferred, wherein however it has been found that, when the external frame is present, an unfavourable material flow can occur in the casting tool due to the resulting poor distribution of the liquid casting material in the tool, from the middle out into the frame. Such problems are avoided by the holding elements extending e.g. from the combustion air blower, which is positioned centrally around the longitudinal axis. Furthermore, as described, the number of parts can be further reduced (the third housing element may be omitted, and hence also a further joining gap, with the consequence of further reduced leakage of heating air, etc.).

With this measure, the combustion air blower can be cast in a diecasting tool with multiple cavities. The milling machining for the latch-clip connections and cable outlets is not required. This leads to a cost reduction for the individual component and also a reduction in tool secondary costs over an entire service life.

Furthermore, additional mounting elements, such as the holder/fastening of the corresponding control unit (ECU), may be integrated in the same casting for the combustion air blower. This gives a further cost optimization in production, logistics and maintenance due to the lower number of individual parts.

According to a particular exemplary embodiment, at least four of the holding elements are provided. Thus, for example, for the typical square cross-sectional profile of the external housing, the four corners and/or also the four faces of the housing elements can be supported, so that with little use of material, a high degree of stability and mechanical integrity is achieved.

According to a refinement of said exemplary embodiments, each of the holding elements comprises a web extending towards the outside from a housing portion of the combustion air blower housing component, and a supporting portion contacting the external housing. Here, according to a further refinement, the respective supporting portion contacting the external housing may form a free end of the corresponding holding element. With this structure, the supporting portion can assume a structure similar to a foot, which distributes the supporting force locally over the surface of an inner wall of the corresponding housing element.

In the state in which the first housing element and the second housing element are latched together, the respective supporting portion contacting the external housing may optionally contact and support both the first housing element and also the second housing element. Advantageously, this option can stabilize the latching and avoid unintentional release.

According to an exemplary embodiment based thereon, the first housing element and/or the second housing element may have a receiving portion, which is formed on an inner wall of the housing element concerned. The respective receiving portion may here extend in the axial direction, starting from an edge face at which the first housing element and/or the second housing element lie opposite one another in assembled state. In this case, the respective receiving portion may be configured to receive the respective supporting portion, which contacts the external housing, slidingly in the axial direction up to a stop face.

According to a refinement, both the first housing element and also the second housing element may each have a receiving portion which, in assembled state, lie opposite one another in the axial direction and establish a common receiving region which, by form fit with the supporting portion, establishes an axial position of the holding element. Optionally, in this context too, a latching (latch connection) of the housing element with the e.g. foot-like contact portion may be provided (optional embodiment, not shown below).

According to a refinement of the air heater, both the first housing element and the second housing element may have a substantially square or rectangular cross-sectional profile in a respective plane perpendicular to the longitudinal axis, wherein a respective one of the supporting portions contacts and supports one of the four corners of the cross-sectional profile of the first housing element and/or the second housing element. The arrangement may optionally be designed such that the entirety of the holding elements has a generally X-shaped structure, viewed in the direction along the longitudinal axis. Thus a particularly high degree of stability is achieved with a low number of holding elements.

According to an exemplary embodiment of the air heater, the combustion air blower housing component is a diecasting, preferably of aluminium or an alloy thereof. In addition or alternatively, both the first housing element and the second housing element may each be integrally formed plastic mouldings. Preferably, the integrally formed housing elements each comprise at least one receiving portion, preferably several receiving portions, which are formed integrally in the plastic moulding.

According to an aspect of the above inventive concept, a corresponding method is also provided for assembling an air heater as described above, in order to achieve the one or other fundamental objects. The method comprises the steps:
providing the subassembly for generating heat, the heat exchanger element thermally interacting therewith, the combustion air blower module and the heating air blower, preferably in a pre-mounted state;
fitting the first housing element and the second housing element in a respective opposite axial direction, parallel to the longitudinal axis;
latching the first housing element and the second housing element to one another or to the combustion air blower module.

Further advantages and features of these first inventive aspects are evident from the following detailed description of exemplary embodiments.

Some of the objects cited initially are also achieved by an air heater according to a further aspect. In a similar fashion to the first aspects, this is based on an air heater, in particular a fuel-based air heater, for a vehicle, which comprises an subassembly for generating heat, a heat exchanger element thermally interacting with the subassembly, and a combustion air blower module comprising a combustion air blower which is powered by a motor (M) and is configured, during operation, to draw in combustion air and supply the combustion air to the subassembly for generating heat. Further components, which are cited above in relation to the first aspects, are also possible, in particular a heating air blower and an external housing, which for example may—but need not—also have the above-described structure.

The air heater establishes a longitudinal axis L extending parallel to a drive shaft of the motor. Since, as described above, in air heaters such a shaft usually coincides with a line through the openings of the heating air inlet and heating air outlet, or at least lies close to and parallel thereto, there is no contradiction with the definition given above.

The air heater furthermore comprises the electric motor (M) for driving the combustion air blower, and a control unit (ECU: electronic control unit) for controlling the motor, and a holder for holding the control unit. Control unit here means the unit including electronic and mechanical components, which may be a control circuit board equipped with a controller and electronic components, (internal) electrical lines, terminals, plugs, sockets and in particular also the housing with fitting elements etc. The holder may be arbitrary in the general sense of the present aspect; preferably, its fixing and/or positioning on the combustion air blower module is as described above.

It is characteristic of the present aspect that this control unit is provided with at least one latching element as such a fitting element, which interacts with a corresponding carrier element of the holder in a latch connection in order to fasten the control unit to the holder. The fundamental concept is that the control unit, which on assembly of the air heater is usually mounted from the side, i.e. in the radial direction perpendicular to the longitudinal axis, need no longer be attached to the motor and/or holder of the blower module (or the blower housing itself) by screw connections with screws and threaded bores, but by simple latching. During mounting, the control unit can thus simply be clipped on. Tests have shown that a corresponding design of the latch connections—in some cases, supported by the features given in the refinements—gives a robustness of the connection which is adequate for use in vehicles, guaranteeing the durability of the air heater. In contrast to fixing by screw connections, with clip-fitting, no additional turning of the heater need be performed in the assembly line. Also, to this end, no additional device is required—rather, the air heater can remain in the workpiece carrier in the main mounting direction throughout, which reduces production time, costs and also the number of parts. In this way, the control unit can rather be mounted on the blower housing or on a correspondingly provided holder with simple manual actions. Additional mounting elements, such as e.g. screws, are not required.

According to a refinement of the present aspect of the invention, the holder comprises two of the carrier elements which extend, starting from the combustion air blower module component, parallel to the longitudinal axis L. In this case, the control unit may be provided with at least two latching elements, preferably four latching elements, each one of which interacts with one of the carrier elements, in the preferred case each two of which interacte with one of the carrier elements. By the two, in particular however four, separate latch connections, the position and orientation of the control unit on the holder are significantly stabilized.

A particular embodiment provides that the two carrier elements are configured as angled tabs. This offers a particularly simple structure which facilitates clip-fitting, while the angling stabilizes the carrier elements against applied forces.

According to an exemplary embodiment suitable for this, the combustion air blower module may comprise a combustion air blower housing component which is formed as one piece and at least partially forms the combustion air blower. Starting from this, the corresponding carrier element may extend parallel to the longitudinal axis L.

A particularly advantageous refinement of this exemplary embodiment provides that the two carrier elements are formed as one piece with the combustion air blower housing component. In the case that the combustion air blower housing component is produced as a diecasting, this firstly saves components. At the same time, the construction with e.g. parallel extending angled tabs is totally compatible with the diecasting in the same mould. In addition, a further mounting process with a screw fastening of the holder can be omitted.

According to an embodiment, the latching elements in the respective latch connection extend perpendicularly to the respective carrier element concerned and parallel to one another, in order to allow the control unit, during its mounting, to be clipped onto the holder in a movement directed radially inwards towards the longitudinal axis. This further facilitates assembly of the air heater.

The control unit or ECU may have a control unit housing which receives the electronics (circuit board, controller, electronic components, lines etc.). The latching elements may extend from the control unit housing. Preferably, they are formed as one piece with the control unit housing, e.g. made from a plastic. This saves costs and effort and reduces the number of components.

Furthermore, the control unit housing may have a respective bearing protrusion or block, via which it bears on the carrier element. When the control unit is in clipped-on state, this bearing protrusion and a latching lug of the latching element fix the carrier element between them in the direction perpendicular to the longitudinal axis. The bearing protrusion to some extent forms the opposite contact face to the contact face of the latching lug. A spacing between contact faces corresponds to the height of the carrier element in the engagement direction. This unambiguously fixes the position of the control unit housing in the height direction. The term “bearing protrusion or block” should not be interpreted too narrowly. This means merely a position on a region of the outer surface adapted to the control unit housing.

According to further exemplary embodiments of the air heater according to the invention, a first connection cage with exposed circuit board contacts therein is formed in the control unit housing of the control unit. A second connection cage with exposed motor contacts therein is formed on a housing of the motor. The second connection cage is configured to be received in the first connection cage, in order to create an electrical connection between the circuit board contacts and the motor contacts. Because of these measures, no separate cable for the power supply need be mounted on the motor. A complex production, mounting and routing of the cable are not therefore required. The motor contacts are rather contacted directly via the circuit board contacts on the control circuit board and hence by the outputs of the control circuit board.

In a refinement of this concept, when the motor is fixed to the combustion air blower housing component (this may take place conventionally by screw fastenings) and the control unit is clipped onto the holder, the second connection cage is received in the first connection cage and the resulting form-fit connection fixes the control unit, in particular also in a transverse direction (perpendicular to the radial or clip-fitting direction) of the air heater, e.g. along the longitudinal axis L. The direct plug-in connection (without cable guide) leads to an additional fixing of the control unit housing in the air heater. In the example, the second connection cage is formed protruding on the motor, while the first connection cage is formed recessed into the surface of the control unit housing. The second connection cage may be formed in a motor bearing plate of the motor as an injection-moulding.

Optionally, for this, a circumferential seal may be provided on the inside on the first connection cage or on the outside on the second connection cage, so that a space with the mutually contacting circuit board contacts and motor contacts inside the two connection cages is sealed against moisture and dirt.

Advantageously, the circuit board contacts may be arranged directly on a control circuit board of the control unit and protrude into the first connection cage, which is configured as a recess in the control unit housing. This saves space in the control unit housing and further reduces the number of components.

The concept of connection cages which plug into one another on the motor and on the control unit offers some advantages: no additional cable need be mounted on the motor. A complex production, mounting and routing of the cable are also not required, since the motor contacts can make direct contact with the control circuit board.

For the radial seal, only three components need be matched to one another, namely the inner geometry of the first connection cage in the control unit housing, the receiver for the rubber seal, e.g. on the outside of the second connection cage of the motor, and the seal. The component dimensions necessary for the seal can easily be produced with the general tolerances of the respective production process. An additional reworking of the functional faces on the connection cages can therefore be omitted.

Because, furthermore, the necessary radial forces for compressing the radial seal are applied by the joining of the two parts together—depending on the design of the internal dimension of the first connection cage relative to the external dimension of the seal, which is formed for example from rubber—no additional press forces, such as e.g. by screws, are required. Also, in contrast to an axial seal, in the force shunt, no precise stops are required in the joining direction (parallel to the clip-fitting direction), since the present radial seal allows a sliding seat in the joining direction. This allows a significantly greater axial tolerance (here viewed in the joining direction). Associated therewith, accordingly significantly cheaper connections between the control housing and the electric motor are possible. By clipping the control unit onto the holder and joining it to the motor, all screws or similar fixings can be omitted.

Further advantages and features of these second aspects according to the invention are also evident from the following detailed description of exemplary embodiments.

### BRIEF DESCRIPTION OF THE DRAWINGS

The invention is explained as an example below with reference to the appended figures.

In the drawings:

FIG. 1 shows, in a schematic overview, a longitudinal sectional view of a conventional fuel-powered air heater;

FIG. 2 shows a perspective view of a fuel-powered air heater according to a first exemplary embodiment, during fitting of the housing elements;

FIG. 3 shows, like FIG. 2 but in enlarged illustration, the latch connections of the housing elements;

FIG. 4 shows a perspective view of a combustion air blower module of the air heater from FIG. 2;

FIG. 5 shows a perspective view of the combustion air blower module from FIG. 4 without the outer (third) housing element;

FIG. 6 shows a lateral, longitudinal sectional view of the fuel-powered air heater according to the first exemplary embodiment;

FIG. 7 shows a perspective view of the external housing of the air heater from FIG. 2 in assembled or latched state;

FIGS. 8A,B show a perspective view of the combustion air blower module of the fuel-powered air heater according to the first exemplary embodiment, before (FIG. 8A) and after (FIG. 8B) fitting of a holder for an electronic control unit;

FIG. 9 shows a perspective view of a fuel-powered air heater according to a second exemplary embodiment;

FIGS. 10A,B show an axial plan view (FIG. 10A) and a perspective view (FIG. 10B) of a combustion air blower module of the fuel-powered air heater according to the second exemplary embodiment, with an integrated holder for an electronic control unit;

FIG. 11 shows a perspective view of the fuel-powered air heater according to the second exemplary embodiment, before fitting of the external housing consisting of two housing elements;

FIG. 12 shows, like FIG. 11 but in perspective view, a section perpendicular to a longitudinal axis through the structure of internal components of the air heater from FIG. 9 (with external housing removed), in a viewing direction from the housing of the combustion air blower (in front) to the heating air blower (behind);

FIG. 13 is like FIG. 11, but with first housing element fitted;

FIG. 14 is like FIG. 12, but with first housing element fitted;

FIGS. 15A,B show an enlarged perspective view of extracts of a receiving portion of the second housing element (FIG. 10A) and the receiving holding element on the combustion air blower module;

FIG. 16 shows a section through the second housing element in perspective view;

FIG. 17 shows a section through the first housing element in perspective view;

FIG. 18 is like FIG. 12 or 14, but now also with fitted second housing element, wherein the section through the air heater according to the second exemplary embodiment lies at the height of the combustion chamber;

FIG. 19 shows a perspective view of the combustion air blower module with motor fitted thereon and with mounted control unit according to the second exemplary embodiment, viewed from obliquely below;

FIG. 20 is like FIG. 19, but from a different perspective (from obliquely above);

FIG. 21 shows a perspective view of the electronic control unit or its control unit housing according to the second exemplary embodiment;

FIG. 22 shows a plan view of the combustion air blower module with motor fitted thereon, during the clip-fitting or mounting of the control unit;

FIG. 23 is like FIG. 22, but with mounted control unit;

FIG. 24 shows an enlarged illustration of the latching element of the control unit in the state latched to the holder of the combustion air blower module;

FIGS. 25A,B show a cross-section (FIG. 25A) and a side view (FIG. 25B) of the electric motor of the air heater according to the second exemplary embodiment, with a second connection cage on the motor side;

FIG. 26 shows a perspective view of the control circuit board with circuit board contacts fitted thereon, for a first connection cage on the control unit side;

FIG. 27 shows a perspective view from below of the control unit with the first connection cage arranged (recessed) in the control unit housing;

FIGS. 28A,B show a sectional view of a state of the motor and control unit before fitting (clip-fitting-FIG. 28A) and after fitting of the control unit;

FIG. 29 shows a perspective view of the circumferential seal, shown in FIGS. 28A and B, for the connection cages;

FIGS. 30A,B show an axial plan view (FIG. 30A) and a perspective view (FIG. 30B) of the control unit and motor parts coupled together.

### DETAILED DESCRIPTION:

In the following description of the drawings, the same reference signs designate the same or comparable components. The features of the invention disclosed in the above description, in the drawings and in the claims may be essential for the implementation of the invention, both individually and also in arbitrary combination.

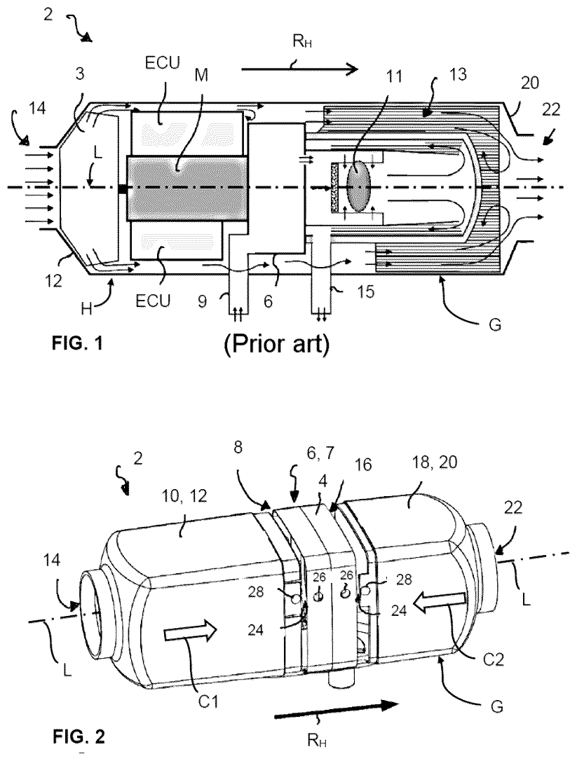

FIG. 1 shows a schematic, longitudinal sectional view, giving an overview of a conventional fuel-powered air heater 2, by means of which the fundamental structure also applicable to the exemplary embodiments will be explained. The air heater 2 is intended e.g. for use in a motor vehicle. The air heater 2 has an external housing G with an intake opening or heating air inlet 14 for heating air H, and with an output opening or heating air outlet 22 for the warmed heating air H. A combustion chamber housing with a fuel-powered combustion chamber 11 is situated in a heat exchanger element 13 of the air heater 2. A combustion air blower, which is arranged in a combustion air blower module 6 and configured as a side channel compressor (not shown in detail), ensures the supply and throughflow of combustion air in the combustion chamber 11. The combustion air blower is connected to a laterally arranged combustion air inlet 9, via which it draws in the combustion air. The figure does not show in detail a fuel supply line (which is however given reference sign 38 below), a vaporizer for the fuel, and an ignition apparatus for starting a combustion process. The fuel and the combustion air containing the oxidizer (e.g. oxygen) are brought into a chemical reaction in the combustion chamber 11, in order to generate heat.

The heating air H is drawn in from the environment via the heating air inlet 14 by means of a heating air blower 3 on an end face of the air heater 2, and after flowing around the heat exchanger 13 in corresponding heating air channels, emerges in heated state through the heating air outlet 22 on a back side of the air heater 2 opposite the end face.

A generally multipiece external housing G surrounds the functional components of the air heater 2. In the region of the heat exchanger element 13, the heating air channels are formed between the heat exchanger element 13 and an inner wall of the external housing G. In a front region of the external housing G, the heating air H—which is not yet heated—flows around such components as the control unit ECU, the motor M and the combustion air blower module 6, after flowing through an impeller of the heating air blower 3. Purely as an example, the heating air inlet 14 and the heating air outlet 22 of the air heater 2 form a common spatial longitudinal axis L of the air heater 2. As a whole, the heating air H driven by the heating air blower 3 flows accordingly in a direction RH parallel to the longitudinal axis L. The combustion air blower of the combustion air blower module 6, and the heating air blower 3 are jointly driven by a drive motor M, which is controlled by a control device ECU in the known fashion, in particular depending on a required heating power.

On an exhaust gas side of the heat exchanger 13, after combustion in the combustion chamber 11, hot combustion gases flow as a rebound flow against a wall in a region of the heat exchanger which is at the rear in a longitudinal direction. In FIG. 1, the combustion chamber 11 is shown purely schematically, and a flame tube tapering in the flow direction may adjoin this in the usual fashion. After leaving the combustion chamber or flame tube, and after the rebound flow against the wall of the heat exchanger, the combustion gases are deflected sharply through 180° and then flow in the flow direction opposite the heating air flow, on the outside of the heat exchanger 13, to the exhaust gas outlet 15. A heat exchanger structured in this fashion may also be described as a contraflow heat exchanger.

The exhaust gases are here diverted through flow channels which, for better heat transmission, are formed by ribs (not shown) protruding towards the inside from an inner surface of the heat exchanger 13 and extending along the longitudinal axis L. With this structure, during operation, the heat exchanger element 13 reaches a maximum temperature in the rear region, the temperature decreasing from back to front as the heat transmission progresses. Accordingly, the heating air in the heating air channels reaches the highest temperatures close to a rear region, before being output from the heating air outlet 22. This configuration, as described to this extent, is also applicable to the exemplary embodiments described below.

FIGS. 2 to 8B show a first exemplary embodiment of a fuel-based air heater 2. Some differences from the example in FIG. 1 are explained below, while with respect to corresponding features, reference is made to the above description.

The air heater 2 has an external housing G formed from two housing shells, as shown in FIG. 2. The two housing shells are here called first housing element 10 and second housing element 18. The first housing element 10 simultaneously forms an air inlet hood 12 which comprises the heating air inlet 14, and the second housing element 18 simultaneously forms an air outlet hood 20 which comprises the heating air outlet 22.

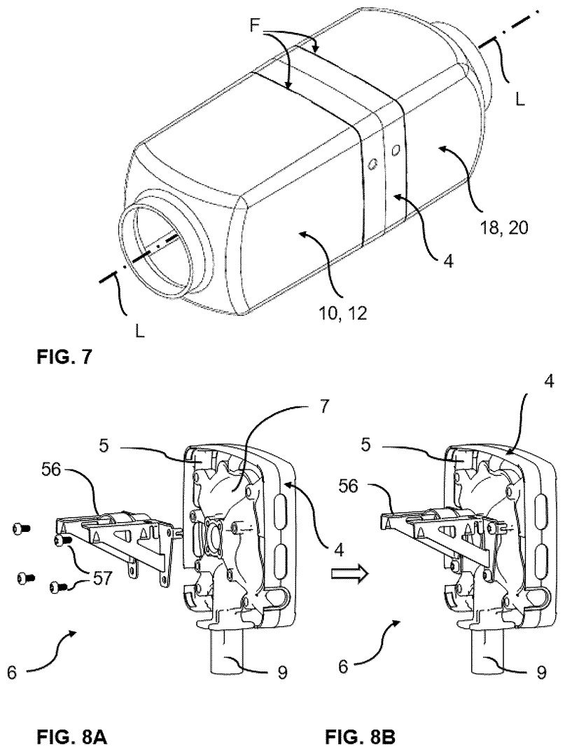

FIG. 2 shows the state of mounting of the housing shells, while FIG. 7 shows the assembled state of the external housing G. For the purpose of mounting, the two housing elements 10 and 18 are brought together in mounting directions C1 and C2, parallel to and along the longitudinal axis L, and latched together. For the latching, the combustion air blower module 6 (shown in greater detail in FIG. 4) is available. In fitted state, this is enclosed by the two housing elements 10 and 18 in the manner of a sandwich.

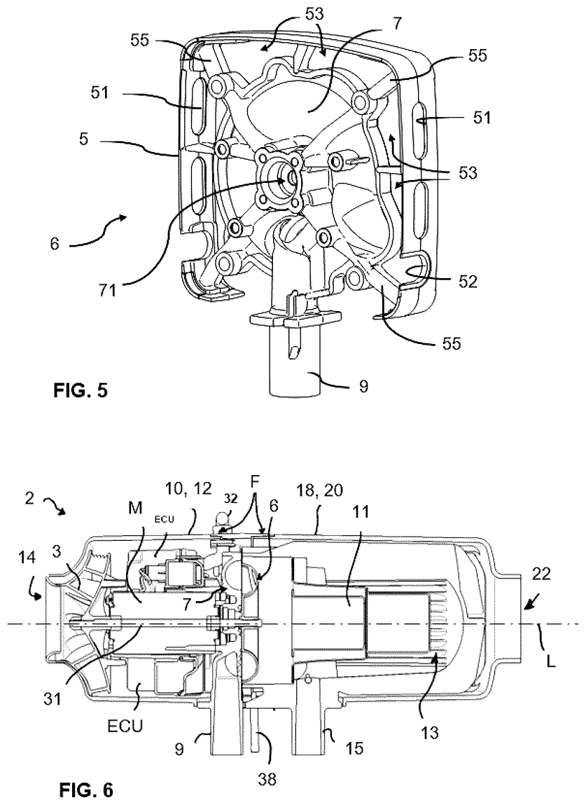

The combustion air blower module 6 comprises the actual combustion air blower which, as shown in FIG. 4, is formed by a combustion air blower housing part 7. The combustion air inlet 9 extends into the combustion air blower. A frame 5, configured as a thin rib, extends all around on the outside and already anticipates the substantially square cross-sectional profile of the external housing G. The frame 5 and the combustion air inlet 9 are formed as an aluminium diecasting, integrally with the combustion air blower housing part 7. The frame 5 is connected to the combustion air blower housing part 7 via struts 55, shown in FIG. 5. Flow openings 53 (see also FIG. 5) for the heating air H are formed between the frame 5, the struts 55 and the combustion air blower housing part 7, so that the heating air can pass from a front part of the air heater 2 into a rear part with the heat exchanger element 13. On the outside, the frame 5 supports over a large area a slender third housing element 4, which may be made from a plastic injection-moulding in the same way as the housing elements 10, 18. Two openings, as first latching elements 26 (to be explained below), are formed in each case on opposite sides in the third housing element 4.

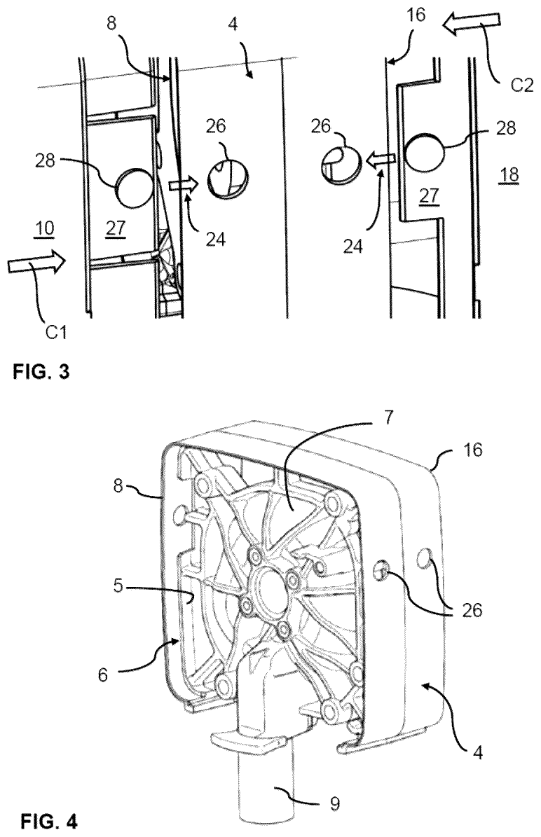

FIG. 3 shows in greater detail a respective latch connection 24 between the third housing element 4 and the first housing element 10 on one side, and the second housing element 18 on the other. On mounting, a front side 16 of the third housing element 4 lies opposite the first housing element 10, and a rear side 8 of the third housing element 4 lies opposite the second housing element 18. The two housing elements 10, 18 each have elastic tabs 27, on which respective protrusions are formed as second latching elements 28. By means of the elastic tabs 27, these elements can engage in the corresponding openings of the first latching elements on the side of the third housing element 4, when the first and second housing elements are pushed together in the axial directions C1, C2 onto the third housing element 4 of the combustion air blower module 6. In assembled state, the combustion air blower module 6 completely supports or carries the external housing G constructed from two shells.

Because of this housing structure of the air heater 2 according to the first exemplary embodiment, during production, a continuous axial orientation of the workpiece carrier is possible, without in particular requiring rotations through e.g. 90°.

FIG. 6 shows a longitudinal section through the air heater 2 according to the first exemplary embodiment. Reference sign 32 indicates an electrical line which supplies power to the air heater. Corresponding cable passages in the external housing are not shown in FIGS. 2, 4 and 7 for the sake of clarity, but in principle are present.

FIG. 5 illustrates an alternative embodiment of the combustion air blower housing component. This shows openings 52 milled at the corresponding positions in the frame 5 for the cable outlets. Furthermore, fastening holes 51 for fitting of the first and second housing elements to the frame 5 can also be seen.

These milling processes constitute additional process steps, and in total four latch connections 24 are required (two latch connections on each of the two opposite sides of the air heater 2) in order to achieve a stable external housing configuration. Furthermore, as shown in FIGS. 8A and 8B, an additional holder is required for the control unit ECU which is to control the motor M, requiring additional mounting parts (screws, separate holder) and yet a further joining step. In addition, as described initially, the diecasting process for the combustion air blower housing component 7 imposes high requirements, if also the frame is to be formed integrally with this component. The anchoring point for the casting mould lies in the region of the shaft bearing, which is indicated by the bore 71 for the shaft 31 of the electric motor M in FIG. 5.

Starting from the concept of the first exemplary embodiment shown in FIGS. 2 to 8B, therefore a second exemplary embodiment has been designed which also provides solutions to the points mentioned and further improvements.

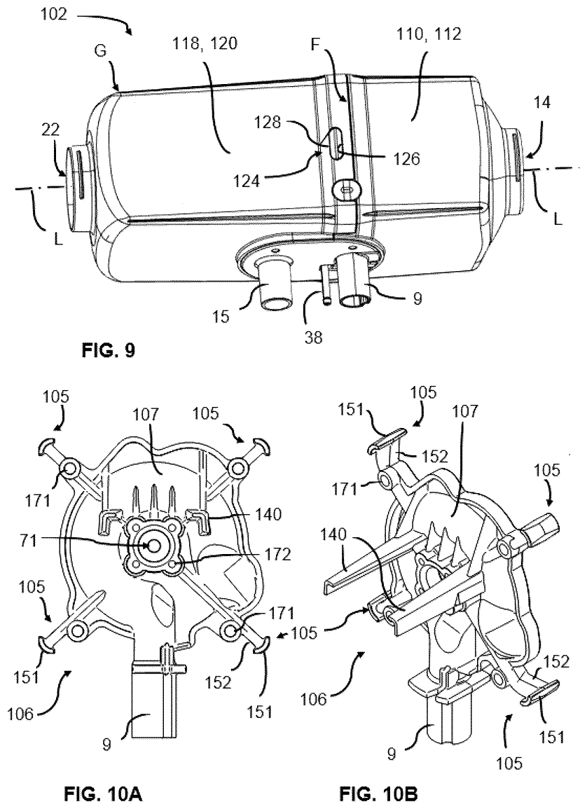

FIG. 9 shows a perspective view of a fuel-powered air heater 102 according to the second exemplary embodiment. It should be noted that the flow direction RH of the heating air H in FIGS. 9 to 30B, concerning the second exemplary embodiment, is from right to left. In the same way as the first exemplary embodiment, here too there is a two-piece housing structure of the external housing G, with a first housing element 110 and a second housing element 118, which here again correspond to a heating air inlet hood 112 with heating air inlet 14 and an air outlet hood 120 with heating air outlet 22. The fundamental functional inner structure of the air heater 102 is the same as described with reference to FIG. 1. FIG. 9 shows the combustion air inlet 9, the exhaust gas outlet 15 and the fuel supply line 38.

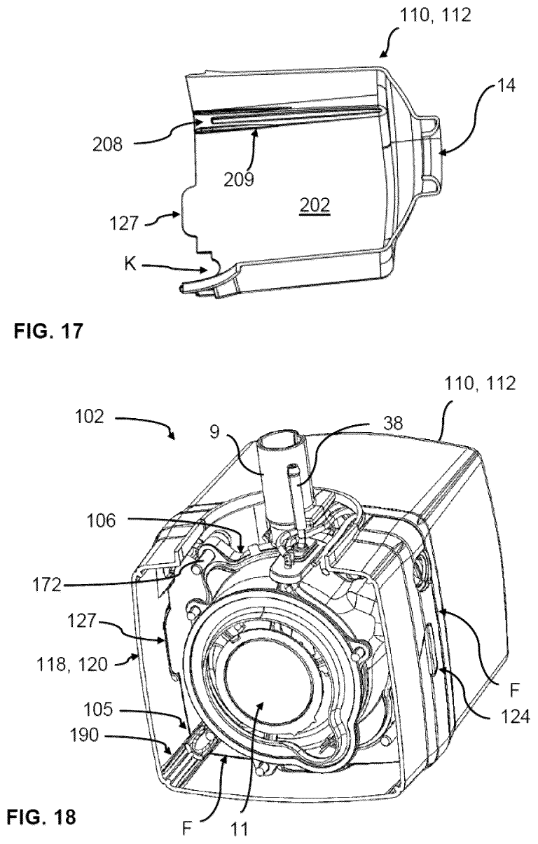

A cable passage (without reference sign) can be seen slightly above the combustion air inlet 9. Even further above in FIG. 9 is a latch connection 124, which is now formed directly between the first housing element 110 and the second housing element 118. This comprises, on the side of the second housing element 118, an opening formed in its wall as the first latching element 126, and on the side of the first housing element 110, a protrusion formed on an outer surface of the first housing element 110 as the second latching element 128. As in the first exemplary embodiment, in the case of latching, the latching elements 126, 128 form a form-fit connection. As shown in FIG. 17, which illustrates a longitudinal section through the first housing element 110, the protruding second latching element 128 is formed on an elastic tab 127, so that the process of latching to the first latching element 126 can be carried out more easily. The two latching elements 126, 128 are formed elongate, so that latching is possible only if the two housing elements are brought together in the axial direction along the longitudinal axis L (which here again is established e.g. by an axis running through a heating air inlet and heating air outlet or, as an equivalent, by an axis running along the shaft of the blower motor M).

This structure already achieves at least the same advantages as the first exemplary embodiment, in particular—inter alia—an axial mounting direction of all housing shells concerned and a reduction in the number thereof. In addition, however, also the corresponding combustion air blower module 106 of the second exemplary embodiment can be simplified, since the third housing element 4 as a docking element is omitted. This also reduces the number of latch connections from four to two (one latch connection on each of the two opposite sides of the air heater). Furthermore, as a comparison of FIG. 7 and FIG. 9 shows, the number of joining gaps F is also reduced from two to one. Accordingly, the heating air leakage from the interior of the air heater 102 is also reduced.

The combustion air blower module 106 according to the second exemplary embodiment is shown in FIGS. 10A and 10B. Here, in comparison with the first exemplary embodiment, not only is the third housing element 4 omitted as part of the combustion air blower module 106, but also the frame 5. Instead, in the second exemplary embodiment, holding elements 105 are provided which extend radially outwards from a portion of the combustion air blower housing component 107. As most clearly evident in FIG. 14, these holding elements 105 support or carry the external housing G or—in the state of FIG. 14—the first housing element 110. The holding elements 105 comprise a web portion 152 and a contact portion 151, which is configured as a foot, in order to bear against an inner wall 202 or 122 (see FIGS. 16 and 17) of the first housing element 110 and the second housing element 118.

The combustion air blower module 106 furthermore comprises a holder 140 which is formed integrally with the combustion air blower housing component 107 and will be explained further below, and bores 171 for fastening the combustion air blower housing component 107 to further components, such as the heat exchanger element 13, in the axial direction. Reference sign 71 here again designates the bore for the bearing of the shaft of the blower motor M. Threaded bores 172 serve for fitting the blower motor M, also in the axial direction. It should be noted that, for stability reasons, the holding elements 105 comprise web portions which also already extend in the radial direction past the combustion air blower housing component 107 into its middle region, so that because the holding elements 105 extend into the four corners of the generally square cross-sectional profile of the external housing G, the design is X-shaped in axial plan view (along the longitudinal axis L), as can be seen particularly clearly in FIG. 10A.

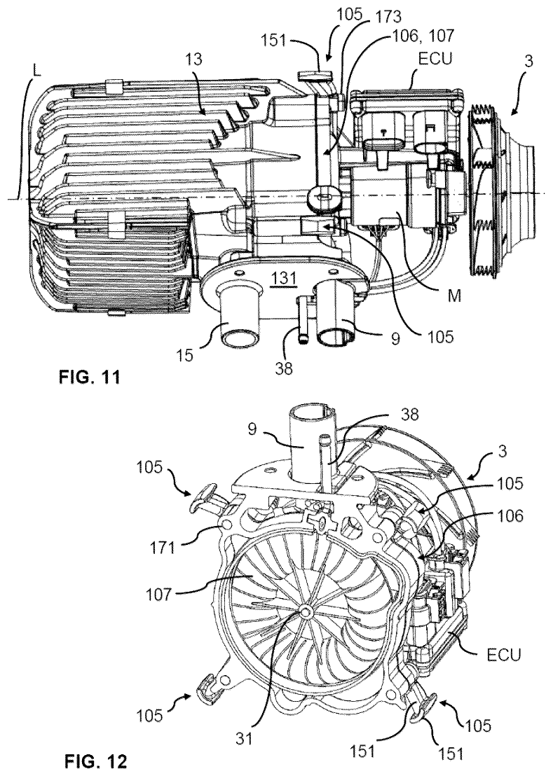

FIG. 11 shows the air heater 102 with external housing G not yet mounted. The components already described with reference to FIG. 1 can be seen. Reference sign 131 designates a sealing plate (part of the heat exchanger element) which covers a region on the underside of the air heater 102. It is formed integrally with the heat exchanger element 13 and therefore is not a plastic injection-moulding, but is made from metal, and in particular is connected to the exhaust gas outlet 15. It closes a region not covered by the housing elements 110 and 118, and thereby seals the interior of the external housing G towards the outside. Sign 173 designates a fastening means for the bore 172 (see FIG. 10A).

FIG. 12 shows the same state as FIG. 11 from a different perspective, but with a section through the air heater, so that the combustion air blower housing component 107 and in particular the side channel impeller housing can be seen. Here too, the shaft 31 for the blower motor can be seen. The impeller for the heating air blower 3 is in the background.

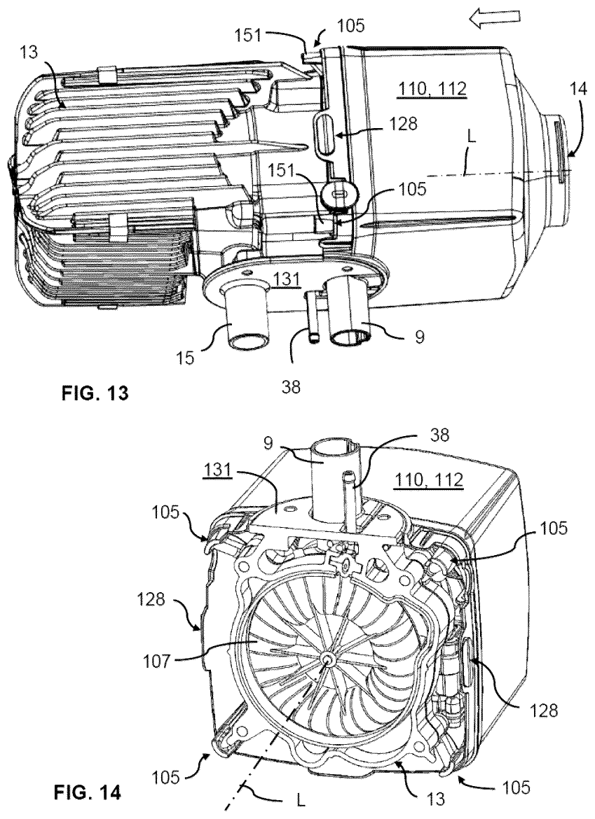

FIGS. 13 and 14 show the state during the mounting process after fitting of the first housing element 110, correspondingly in the perspective side view and the sectional view. The holding elements 105 sit in the four corners of the cross-sectional profile of the first housing element 110, but protrude in the axial direction along the longitudinal axis L from the opening of the fitted first housing element 110.

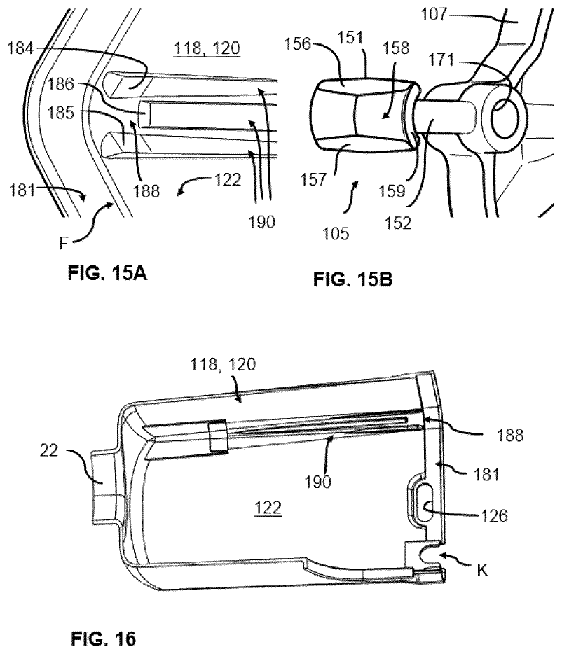

FIG. 15A shows as an example one of the corners of the second housing element 118 in enlarged illustration. The corresponding corner of the first housing element 110 shown in FIG. 14 has substantially corresponding features. A particular feature of the second housing element 118 in this respect is simply a collar portion 181 which, on mounting on the first housing element 110, extends slightly over its outer surface.

In the corners or edges of the two housing elements, ribs 190, 209 (see FIGS. 15 and 16) are formed, of which a middle one is formed shortened towards the outer edge in order to clear a receiving portion 188 for the contact portion 151 of the holding element 105, and to form a stop face 186 which defines the position of the contact portion 151 in the interior of the second housing element 118. The same applies accordingly to the first housing element 110. For this reason, the first housing element 110 also cannot be pushed on further in FIG. 14, so that the holding element 105 semi-protrudes.

FIG. 15B shows a holding element 105 in enlarged illustration. The foot-like contact portion 151 has two opposite stop faces 159, of which in mounted state one hits against the stop face 186 shown in FIG. 15A, and the other hits against the corresponding stop face (not shown) in the first housing element 110. Furthermore, the foot-like contact portion 151 has two lateral contact faces 156, 157 with which it contacts receiving faces 184, 185 of the outer ribs 190 (209 similarly). In this way, a form-fit connection is achieved between the contact portion 151 and a receiving portion 208, similar to the receiving portion 188 from FIG. 15A, on the side of the first housing element 110 (see FIG. 17).

The second housing element 118 is then fitted, as FIG. 18 shows (the section through the air heater is here pulled further in the backward direction, and at the front the second housing element 118 is visible all around). Here, now, the part of the contact portion 151 still protruding from the first housing element 110, of the holding element 105 enters the corresponding receiving portion 188 of the second housing element 118. In this state, the receiving portions 188, 208 are contacted by the contact face 158 of the foot-like contact portion 151. Because of the X-shaped configuration of the four holding elements 105, during mounting, the foot-like contact portions 151 each slide with precise fit into the receiving portions 188, 208 of the corresponding opening of the housing element 110, 118 concerned, until the associated stop faces 186, 159 of the foot-like contact portion 151 and the two housing elements 110, 118 meet one another. In the state in which the latch connections 124 are created, the four stop faces 186, 159 etc. contact one another, so that the axial position of the housing elements 110, 118 relative to the combustion air blower module 106 is fixed. Because of the form fit of the X-shaped structure, a rotation of the external housing about the longitudinal axis L is also excluded. It should be noted that two latch connections 124 alone are sufficient for this, and no further screw connections are required.

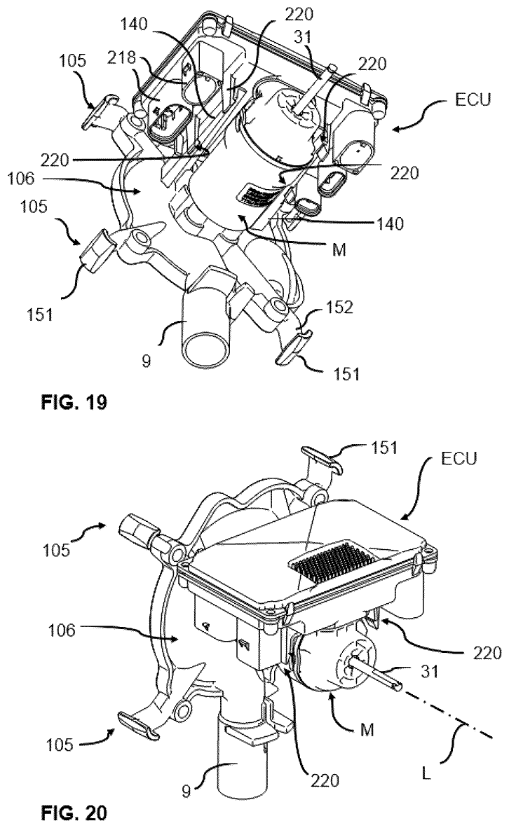

FIGS. 19 and 20 show perspective views of the combustion air blower module with motor M fitted thereon and with mounted control unit ECU according to the second exemplary embodiment, with viewing direction from obliquely below and from obliquely above. The electric motor M is fitted directly on the combustion air blower module 106 by means of screws (see the bores 172 in FIG. 10A). The control unit ECU is fitted on the holder 140, here by clip-fitting from the lateral direction, by means of four latch connections 300 (see FIG. 24).

The holder 140 comprises two angled tabs, which extend linearly along the longitudinal axis L from the combustion air blower housing part 107 and parallel to one another, and which have a vertical portion (first angle face 142) and a horizontal portion (second angle face 144). The portions 142, 144 stand for example perpendicularly to one another, see FIG. 24. The angled tabs may be produced integrally with the aluminium diecasting of the combustion air blower housing part 107, which further reduces the total number of components.

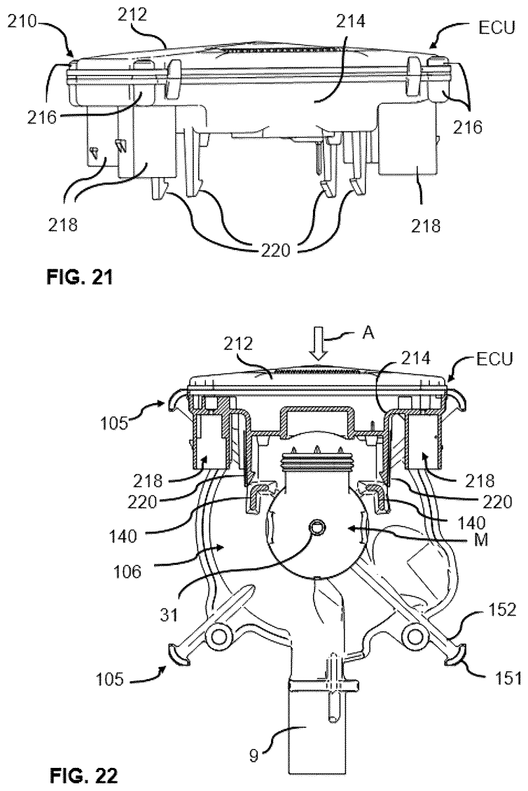

FIG. 21 shows the control unit ECU in greater detail. It comprises a control unit housing 210 which has a lid 212 and a housing lower part 214. The structure of the control unit housing 210 is generally flat, in order to receive therein a control circuit board 260, shown in FIG. 26. The control circuit board 260 establishes a plane in the control unit housing 210, wherein a direction A of clip-fitting of the control unit housing 210 lies perpendicular to this plane. Some connection sockets 218, oriented in the clip-fitting direction A, are formed on the housing lower part 214 and allow an electrical connection of the control unit ECU to the on-board network (communication and power supply) of the vehicle, see also the above-discussed cable passage K in FIGS. 13, 16 and 17, and electrical line 32 in FIG. 6 concerning the first exemplary embodiment.

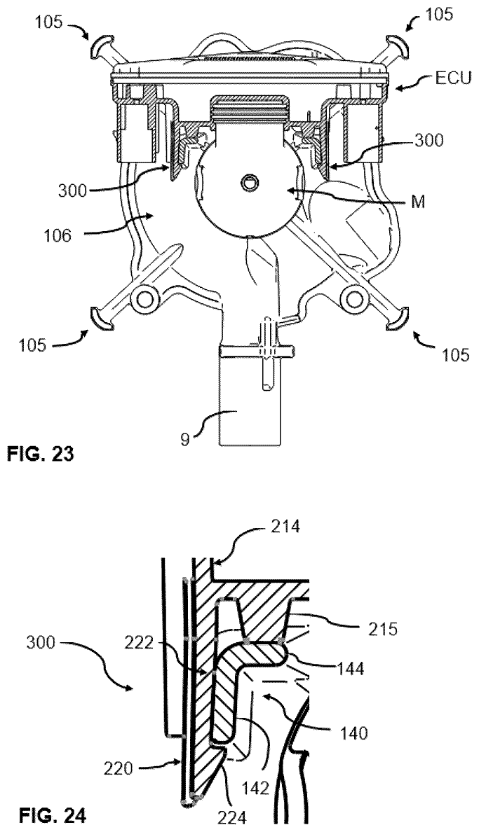

In particular, however, four latching elements 220—also extending in the clip-fitting direction A—are provided, which extend parallel to one another from the housing lower part 214. As shown in the enlarged illustration in FIG. 24, these each comprise a flexible latching arm 222 and a latching lug 224. In each case, one latching element and one of the two angled tabs of the holder 140 form a latch connection 300. In each case, two latching lugs 224 of the latching elements face one another, so that during clipping onto the holder 140, the latching elements 222 grip around the outside of the angled tabs; in engaged state, the latching arms 222 conform closely to the outside of the vertical portions (angle faces 142), and the latching lugs grip under a distal end of the vertical portions (angle faces 142), so that the control unit housing 210 can no longer be released against the clip-fitting direction A. Furthermore, on the underside of the housing lower part 214, bearing protrusions 215 are formed which, in a state in which the latching lugs 224 engage below the angled tabs of the holder 140, contact said latching tabs from above and thereby limit a further movement in the clip-fitting direction A. Thus the control unit ECU is fixed by form fit in the clip-fitting direction A, which lies perpendicular to the extent direction of the angled tabs and to the longitudinal axis L. The process of clip-fitting is shown in FIGS. 22 and 23.

FIG. 27 shows the underside of the housing lower part 214 of the control unit housing 210 in greater detail. As well as the laterally arranged, raised connection sockets 218 for connection via plugs to cables or electrical lines, in the middle position, a first connection cage 260 is formed as a recess in the surface of the housing lower part 214. From the interior of the control unit housing 210, three circuit board contacts 262, formed as fork-like contacts, protrude into this first connection cage 260. The fork-like shape creates a flexible and reliable connection to the e.g. pin-like or plate-like motor contacts 250. The circuit board contacts 262, as shown in FIG. 26, are arranged directly on the circuit board and connected to electronic components provided there, which allow control or operation of the motor M. Adjacent to the first connection cage 264, a cylindrical recess 217 is formed in the surface of the housing lower part 214, the shape of which recess is complementary to the cylindrical housing of the electric motor M (see FIG. 19 for example).

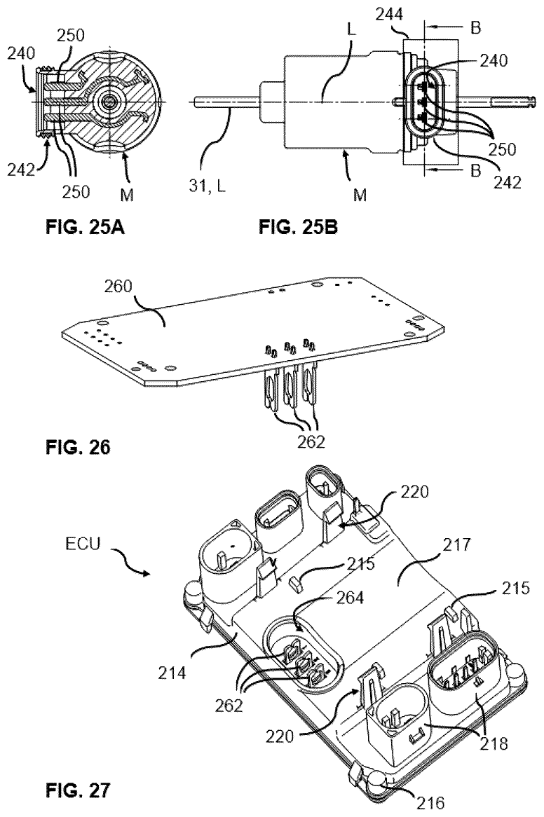

FIGS. 25A and 25B show, in cross-sectional view (FIG. 25A) and in side view (FIG. 25B), the electric motor M of the air heater according to the second exemplary embodiment. The motor M has three motor contacts 250 for connection of the e.g. three phases of the motor M. The motor contacts 250 are arranged inside a second connection cage 240 on the motor side, which is injection-moulded together with a motor bearing plate 244 and has a shape and external dimensions which allow it to fit precisely into the recess of the first connection cage 264.

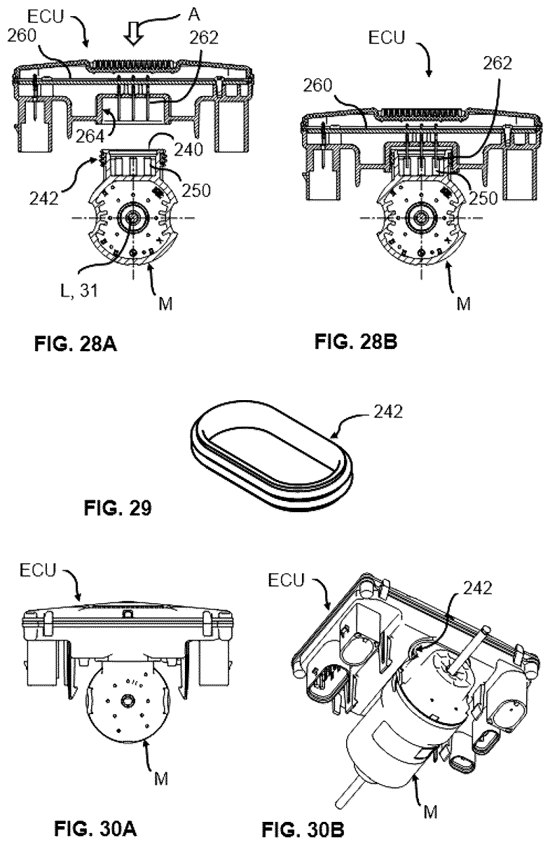

FIGS. 28A and 28B show the contacting of the electric motor M to the control unit ECU. A sealing ring 242 (shown in FIG. 29) is formed on an outer edge of the second connection cage 240, in order to seal an inner space formed by the two connection cages 240, 264 when they are pushed together. FIGS. 30A and 30B show the mounted state of the motor M and control unit ECU from different perspectives. Here, the combustion air blower module 106 is not shown.

FIGS. 22 and 23 show the clip-fitting process, including the combustion air blower module 106 with the holder 140. The enlargement in FIG. 24 should be consulted here. The clip-fitting to create the latch connection 300 is here accompanied by the insertion of the second connection cage 240 on the motor side in the first connection cage 264 on the control unit side. The latter connection fixes the control unit by form fit, in particular in a direction perpendicular to the clip-fitting direction A, e.g. along the longitudinal axis L, so that e.g. a sliding of the control unit along the angled tabs is eliminated. In total, this gives the control unit a mechanically stable and reliable positioning without the use of screw connections.

It should be noted that although the embodiments of FIGS. 9 to 18 firstly, and FIGS. 19 to 30B secondly, concern the same exemplary embodiment, they concern mutually independent improvements and may each be implemented without the other improvement, for which reason they are also considered above as different aspects of the invention. However, synergy effects from the combination can evidently not be excluded.

### LIST OF REFERENCE SIGNS

2 Air heater
3 Heating air blower
4 Third housing element
5 Holding element for the external housing (frame structure)
6 Combustion air blower module
7 Combustion air blower housing part
8 Back side (third housing element)
9 Combustion air inlet
10 First housing element
11 Combustion chamber
12 Air inlet hood
13 Heat exchanger element
14 Heating air inlet
15 Exhaust gas outlet
16 Front side (third housing element)
18 Second housing element
20 Air outlet hood
22 Heating air outlet
24 Latch connection
26 First latching element
27 Elastic tab
28 Second latching element
31 Shaft (blower motor)
32 Electrical line
34 Supporting structure
36 Heater module
38 Fuel supply line
51 Fastening holes
52 Openings for cable outlets
53 Flow opening (for heating air)
55 Radial struts
56 Holder for control unit
57 Screws for fastening the holder
71 Bore in combustion air blower module for shaft
102 Air heater
105 Holding element for the external housing
106 Combustion air blower module
107 Combustion air blower housing part
110 First housing element
112 Air inlet hood
118 Second housing element
120 Air outlet hood
122 Inner wall (air outlet hood)
124 Latch connection
126 First latching element
127 Elastic tabs
128 Second latching element
131 Sealing plate (part of heat exchanger element)
140 Holder for control unit (support tabs)
141a, b Angled tab
142 First angle face
144 Second angle face
151 Supporting portion
152 Radial web
156 Contact face
157 Contact face
158 Contact face
159 Stop face (in axial direction)
171 Bores for fastening the heat exchanger element
172 Bores for fastening the motor
173 Fastening means for bores 171
181 Collar portion
184 Receiving face (in circumferential direction)
185 Receiving face (in circumferential direction)
186 Stop face (air outlet hood, in axial direction)
188 Receiving portion (air outlet hood)
190 Ribs (air outlet hood)
202 Inner wall (air inlet hood)
206 Stop face (air inlet hood, in axial direction)
208 Receiving portion (air inlet hood)
209 Ribs (air inlet hood)
210 Control unit housing
212 Lid
214 Housing lower part
215 Bearing protrusion
216 Lid fastening
217 Receiver in housing lower part for cylindrical motor housing
218 Connection sockets (control unit)
220 Latching elements (control unit)
222 Latching arm
224 Latching lug
240 Connection cage (motor)
242 Seal on motor-side connection cage
244 Motor bearing plate
250 Motor contacts
260 Control circuit board
262 Fork-like circuit board contacts
264 Connection cage (control unit)
300 Latch connection
A Lateral fitting direction (radial direction)
C1, C2 Mounting directions for the housing elements
ECU Control unit
F Joining point
G External housing
H Heating air
K Cable passage
L Longitudinal axis
M Motor
R_{H} General direction of heating air flow

1. An air heater for a vehicle, comprising:
a subassembly for generating heat;
a heat exchanger element thermally interacting with the subassembly;
an external housing which receives the subassembly and the heat exchanger element, wherein the external housing and the heat exchanger element form a heating air channel between them;
a heating air blower, which is configured to draw in heating air via a heating air inlet of the external housing, convey this in a flow direction through the heating air channel and output it via a heating air outlet of the external housing;
a combustion air blower module comprising a combustion air blower which is powered by a motor and is configured, during operation, to draw in combustion air and supply the combustion air to the subassembly for generating heat,
wherein the air heater establishes a longitudinal axis extending through the heating air inlet and the heating air outlet,
characterized in that
the combustion air blower module is configured to carry the external housing;
the external housing comprises a first housing element and a second housing element as separate components; and
the combustion air blower module, the first housing element and the second housing element are assembled together in an axial direction parallel to the longitudinal axis.

2. The air heater according to claim 1, wherein
the first housing element and the second housing element are latched together in the axial direction parallel to the longitudinal axis by at least one latch connection.

3. The air heater according to claim 1, wherein
the combustion air blower module comprises a combustion air blower housing component which is formed as one piece and at least partially forms the combustion air blower; and
the combustion air blower housing component has a number of holding elements which extend substantially in the radial direction away from the longitudinal axis and support the external housing from the inside.

4. The air heater according to claim 3, wherein
at least four of the holding elements are formed.

5. The air heater according to claim 3, wherein
each of the holding elements comprises a web extending towards the outside from a housing portion of the combustion air blower housing component, and a supporting portion contacting the external housing.

6. The air heater according to claim 5, wherein
the respective supporting portion contacting the external housing forms a free end of the corresponding holding element.

7. The air heater according to claim 5, wherein
in the state in which the first housing element and the second housing element are latched together, the respective supporting portion contacting the external housing contacts and supports both the first housing element and the second housing element.

8. The air heater according to claim 5, wherein
at least one of: the first housing element and the second housing element has a receiving portion which is formed on an inner wall of the housing element concerned,
wherein the respective receiving portion extends in the axial direction starting from an edge face, at which at least one of: the first housing element and the second housing element lie opposite one another in assembled state,
wherein the respective receiving portion is configured to receive the respective supporting portion, which contacts the external housing, slidingly in the axial direction, up to a stop face.

9. The air heater according to claim 7, wherein
both the first housing element and the second housing element each have a receiving portion which, in assembled state, lie opposite one another in the axial direction and establish a common receiving region which, by form fit with the supporting portion, establishes an axial position of the holding element.

10. The air heater according to claim 5, wherein
both the first housing element and the second housing element have a substantially square or rectangular cross-sectional profile in a respective plane perpendicular to the longitudinal axis;
wherein a respective one of the supporting portions contacts and supports one of the four corners of the cross-sectional profile of at least one of: the first housing element and the second housing element.

11. The air heater according to claim 5, wherein
the entirety of the holding elements has an overall X-shaped structure viewed in the direction along the longitudinal axis.

12. The air heater according to claim 1, wherein at least one of:
the combustion air blower housing component is a diecasting; and
both the first housing element and the second housing element are each integrally formed plastic mouldings.

13. A method for assembling an air heater comprising:
provision of a subassembly, a heat exchanger element thermally interacting therewith, a combustion air blower module and a heating air blower;
fitting of a first housing element and a second housing element in a respective opposite axial direction, parallel to a longitudinal axis;
latching of the first housing element and the second housing element to at least one of: one another and the combustion air blower module.

14. An air heater for a vehicle, comprising:
a subassembly for generating heat;
a heat exchanger element thermally interacting with the subassembly;
a combustion air blower module comprising a combustion air blower which is powered by a motor and is configured, during operation, to draw in combustion air and supply the combustion air to the subassembly for generating heat,
wherein the air heater establishes a longitudinal axis extending parallel to a drive shaft of the motor;
the motor for driving the combustion air blower;
a control unit for controlling the motor;
a holder for holding the control unit;
characterized in that
the control unit is provided with at least one latching element which interacts with a corresponding carrier element of the holder in a latch connection, in order to fasten the control unit to the holder.

15. The air heater according to claim 14, wherein
the holder comprises two of the carrier elements, which extend parallel to the longitudinal axis, starting from the housing component; and
the control unit is provided with at least two latching elements, each one of which interacts with one of the carrier elements.

16. The air heater according to claim 15, wherein
the two carrier elements are configured as angled tabs.

17. The air heater according to claim 15, wherein
the combustion air blower module comprises a combustion air blower housing component which is formed as one piece and at least partially forms the combustion air blower; and
the corresponding carrier element extends parallel to the longitudinal axis, starting from the housing component.

18. The air heater according to claim 15, wherein
the two carrier elements are formed as one piece with the combustion air blower housing component.

19. The air heater according to claim 15, wherein
the latching elements in the respective latch connection extend perpendicularly to the respective carrier element concerned and parallel to one another, in order to allow the control unit, during its mounting, to be clipped onto the holder in a movement directed radially inwards towards the longitudinal axis.

20. The air heater according to claim 19, wherein
the control unit has a control unit housing from which the latching elements extend and with which they are formed as one piece.

21. The air heater according to claim 20, wherein
the control unit housing has a respective bearing protrusion, via which it bears on the carrier element, wherein when the control unit is in clipped-on state, the bearing protrusion and a latching lug fix the carrier element between them in the direction perpendicular to the longitudinal axis.

22. The air heater according to claim 20, wherein
a first connection cage with exposed circuit board contacts therein is formed in the control unit housing of the control unit; and
a second connection cage with exposed motor contacts therein is formed on a housing of the motor;
wherein the second connection cage is configured to be received in the first connection cage in order to create an electrical connection between the circuit board contacts and the motor contacts.

23. The air heater according to claim 22, wherein
when the motor is fixed to the combustion air blower housing component and the control unit is clipped onto the holder, the second connection cage is received in the first connection cage and the resulting form-fit connection fixes the control unit, in a circumferential direction about the longitudinal axis.

24. The air heater according to claim 22, wherein
a circumferential seal is provided at least one of: on the inside on the first connection cage and on the outside on the second connection cage, so as to seal a space with the mutually contacting circuit board contacts and motor contacts inside the two connection cages.

25. The air heater according to claim 22, wherein
the circuit board contacts are arranged directly on a control circuit board of the control unit and protrude into the first connection cage which is configured as a recess in the control unit housing.
